(19) United States
(12) Patent Application Publication
(10) Pub. No.: US 2006/0157211 A1
(43) Pub. Date: Jul. 20, 2006

(54) Composition and method relating to an adhesive for use with paper products

(76) Inventors: Robert A. LaBrash, Roseville, MN (US); Paul A. Englund, Mahtomedi, MN (US); Charles W. Graves, Lake Elmo, MN (US)

Correspondence Address: H.B. Fuller;Patent Department, 1200 Willow Lake Blvd., P.O. Box 64683, St. Paul, MN, 55164-0683, US

(21) Appl. No.: 11/039,095

(22) Filed: Jan. 20, 2005

(51) Int. Cl. B05D 3/12; B05D 3/02; C09D 7/00; C01B 25/00; D21H 11/00; D21H 23/00; C09D 5/16; C08L 91/00; C09D 5/14; C04B 9/02; C09D 4/00; B01F 17/00; C09D 5/18

(52) U.S. Cl. 162/135; 427/395; 427/391; 427/361; 162/160; 162/161; 162/172; 162/173; 162/179; 162/181.1; 162/181.2; 162/181.4; 106/287.35; 106/285; 106/287.26; 106/14.11; 106/14.13; 106/14.14; 106/14.21; 106/15.05; 106/18.29; 106/18.3; 106/18.31; 106/18.32; 106/18.35; 106/18.36; 106/18.34; 106/243; 106/287.24

(57) ABSTRACT

The present invention includes methods and compositions relating to an adhesive that can be applied to oiled or lotioned substrates.

### FIELD OF THE INVENTION

The present invention relates to an adhesive comprising a medium chain or long chain hydrocarbon component, an surfactant, water, a base, and an acidulant. The adhesive can be applied to paper products, especially lotioned paper products.

### BACKGROUND OF THE INVENTION

During production of rolled paper products such as toilet paper, the rolled product must be held in place on the roll to ensure uninterrupted production. That is, if the rolled product begins to unravel, portions of the unraveled product can catch in the production equipment, possibly causing a malfunction.

Typically, the rolled paper products are held in place using an adhesive called a tail-tie adhesive. The adhesive must be strong enough to cause the product to adhere to the roll during production but allow for separation at the point of use. For typical rolled paper products, the tail-tie adhesive composition is a cellulosic adhesive composition.

Certain toilet tissue and other rolled paper products on the market today have an oil and/or a lotion added to the product. Typical tail-tie adhesives are generally rendered inoperable by the oil or lotion in these products, typically called “lotioned” products.

Therefore, there is a need in the art for an adhesive composition that allows for adhesion when used with lotioned paper products.

### SUMMARY OF THE INVENTION

The present invention, in one embodiment, is an adhesive composition. The composition has from about 1% by weight to about 4% by weight of a hydrocarbon component, from about 0.5% by weight to about 5% by weight of a surfactant, from about 0.1% by weight to about 0.8% by weight of a base, from about 0.1% by weight to about 0.4% by weight of an acidulant, and water in an amount such that a total weight of the composition totals 100%.

In an alternative embodiment, the present invention is a method of making the above composition.

The present invention, in another embodiment, is a method of using an adhesive composition. The method includes providing an adhesive composition and applying the composition to a paper product. The adhesive composition has a hydrocarbon component comprising stearic acid and a surfactant.

In a further embodiment, the present invention is a method of using an adhesive composition. The method includes providing an adhesive composition and applying the adhesive composition to a lotioned paper product. The composition has from about 1% by weight to about 4% by weight of a hydrocarbon component comprising stearic acid, from about 0.5% by weight to about 5% by weight of a surfactant, from about 0.1% by weight to about 0.8% by weight of a base, from about 0.1% by weight to about 0.4% by weight of an acidulant, a light hydrocarbon oil comprising a mineral oil, and a coupling agent comprising glycerin.

### DETAILED DESCRIPTION

The methods and compositions of the present invention are directed to an adhesive composition that can used with paper products, especially lotioned paper products. The adhesive is intended for use in various applications, including as a tail-tie adhesive for lotioned toilet tissue.

In one aspect, the present invention is a composition that includes a medium chain or long chain hydrocarbon component (also referred to herein as a “hydrocarbon component”), an surfactant, water, a base, and an acidulant.

The effectiveness of an adhesive composition containing a medium chain or long chain hydrocarbon component in a composition as described herein when used with lotioned products is a surprising result. Prior to the present invention, it was not known that such a composition could produce an adhesive effective when used with lotioned products.

The composition of the present invention is comprised of a hydrocarbon component dispersed in the remaining components of the composition. Alternatively, the composition is a solution, emulsion, or suspension. In a further alternative, the composition is in any known form.

The concentration of the hydrocarbon component in the composition is in an amount ranging from about 1% to about 4% by weight of the composition. Alternatively, the concentration ranges from about 1.5% to about 3.5% by weight. In a further alternative, the concentration ranges from about 2% to about 3% by weight.

According to one embodiment, the medium or long chain hydrocarbon component is a hydrocarbon or mixture of hydrocarbons having a chain length of from about 10 to about 32 carbon atoms. For example, the hydrocarbon component can be a petroleum-based hydrocarbon component, a fatty acid, a fatty acid ester, an aliphatic carboxylic acid, a hydroxy acid, a keto acid, or similar solids/saturated acids, an alkyl ethoxylate, a fatty acid ester ethoxylate, a fatty alcohol, or mixtures thereof. Examples of fatty acid esters include those derived from C₁₂-C₂₈ fatty acids. Examples of alkyl ethoxylate include C₁₂-C₂₂ fatty alcohol ethoxylates having an average degree of ethoxylation of from about 2 to about 30. Examples of fatty alcohol include C₁₂-C₂₂ fatty alcohols.

According to one alternative embodiment, the medium or long chain hydrocarbon component can include small amounts of other components, including, for example, propylene glycol, triethylene glycol, spermaceti or other waxes, fatty acids, and fatty alcohol ethers having from 12 to 28 carbon atoms in their fatty chain.

In one aspect of the invention, the hydrocarbon component is stearic acid. One example of commercially-available stearic acid is Emersol 132 NF Lily Stearic Acid, which can be purchased from Cognis Corporation, which is located at 5051 Estecreek Drive, Cincinnati, Ohio 45232. Alternatively, the stearic acid can be any commercially-available composition of stearic acid.

In accordance with one embodiment, the concentration of surfactant in the composition is in an amount ranging from about 0.5% to about 5% by weight of the composition. Alternatively, the concentration ranges from about 2% to about 3% by weight. In a further alternative, the concentration ranges from about 2.4% to about 2.6% by weight.

The surfactant, according to one aspect of the present invention, is MYRJ™ 45. One source for MYRJ™ 45 is Chemcentral International, which is located at 2287 Collections Center Drive, Chicago, Ill. 60693. Alternatively, the surfactant can be any commercially-available surfactant having a hydrophilic-lipophilic balance (“HLB”) value ranging from about 10.0 to about 12.0. In a further alternative, the surfactant has an HLB value of 11.1.

According to one embodiment, the concentration of water in the composition is in an amount ranging from about 89% to about 98% by weight of the composition. Alternatively, the concentration ranges from about 91% to about 95% by weight of the composition. In a further alternative, the concentration ranges from about 92% to about 94% by weight.

According to one embodiment, the concentration of the base in the composition is in an amount ranging from about 0.1% to about 0.8% by weight of the composition. Alternatively, the concentration ranges from about 0.2% to about 0.7% by weight of the composition. In a further alternative, the concentration ranges from about 0.3% to about 0.6% by weight of the composition. In yet another aspect of the present invention, the concentration of base in the composition is any amount of base that is required to move the pH of the composition into the range of from about 8 to about 9 prior to the addition of the acidulant to the composition. According to one embodiment, the base has an effect similar to the surfactant in that it makes the composition more water soluble or makes the hydrocarbon component more readily dispersable in the water.

According to one embodiment, the base is potassium hydroxide. Alternatively, the base can be, for example, sodium hydroxide, ammonium hydroxide, or triethanol amine. In a further alternative, the base can be any known base for use in an adhesive. One example of an appropriate base is a commercially available solution of 45% potassium hydroxide and 55% water.

According to one embodiment, the concentration of the acidulant in the composition is in an amount ranging from about 0.01% to about 0.4% by weight of the composition, the amount varying depending on the amount required to attain a pH level in the composition ranging from about 6.5 to about 7.5. Alternatively, the concentration ranges from about 0.05% to about 0.15% by weight of the composition. In a further alternative, the concentration ranges from about 0.08% to about 0.12% by weight of the composition. In yet another aspect of the invention, the concentration of acidulant in the composition is any amount of acidulant that is required to move the pH of the composition into the range of from about 6.5 to about 7.5 after the addition of the base to the composition. According to one embodiment, the acidulant has the effect of producing a consistency in the composition of a light, non-stringy paste that provides for easy application to a substrate.

“Acidulant” means any substance that can be added to the composition to lower the pH level of the composition. According to one embodiment, the acidulant is citric acid. Alternatively, the acidulant can be, for example, cream of tartar, tartaric acid, a salt of tartaric acid, hydrochloric acid, sulfuric acid, or hydroxy acetic acid. In a further alternative, the acidulant can be any known acidulant for use in an adhesive. An appropriate citric acid composition can be purchased from Univar Inc., located at 845 Terrace Court, St. Paul, Minn. 55101.

In accordance with an alternative embodiment, the composition of the present invention can also include a light hydrocarbon oil, which is a light hydrocarbon oil having a chain length of from about 16 to about 32 carbon atoms. The concentration of the light hydrocarbon oil in the composition of the present invention is in an amount ranging from about 0% to about 3% by weight. Alternatively, the concentration ranges from about 0.05% to about 1% by weight of the composition. In a further alternative, the concentration ranges from about 0.2% to about 0.4% by weight of the composition.

According to one embodiment, the hydrocarbon oil is a mineral oil. In one aspect of the present invention, the mineral oil is pharmaceutical-grade mineral oil. Alternatively, the hydrocarbon oil can be, for example, naphthenic oil or vegetable oil. In a further alternative, the hydrocarbon oil can be any known light hydrocarbon oil. In one aspect of the invention, the mineral oil has the effect of softening the dry bond of the composition.

In accordance with an alternative embodiment, the composition of the present invention can also include a coupling agent. “Coupling agent” as used herein is intended to mean any substance that can be added to the composition and has a hydrophilic portion and a lipophilic portion that can help to couple the water to the hydrocarbon component in the composition. The concentration of the coupling agent in the composition of the present invention is in an amount ranging from about 0% to about 5% by weight. Alternatively, the concentration ranges from about 0.5% to about 3% by weight of the composition. In a further alternative, the concentration ranges from about 2% to about 3% by weight of the composition.

According to one embodiment, the coupling agent is glycerin. Alternatively, the coupling agent can be, for example, any of the simple glycols, including diethylene glycol, polyethylene glycol, or propylene glycol. In a further alternative, the coupling agent is any known substance having a hydrophilic portion and a lipophilic portion that helps to couple the hydrocarbon component to the water in the composition. In one aspect of the invention, the coupling agent has the effect of softening the dry bond.

In accordance with an alternative embodiment, the composition of the present invention can also include a defoamer. The concentration of the defoamer in the composition of the present invention is in an amount ranging from about 0% to about 0.2% by weight. Alternatively, the concentration is about 0.1% by weight of the composition.

According to one embodiment, the defoamer is an oil-based defoamer such as Rhodoline™ 962 or Colloid 962, which can be purchased from Rhodia Corporation, which is located at 259 Prospect Plains, Cranbury, N.J. 08512. The oil-based defoamer can be either silica or wax. Alternatively, the defoamer can be a silicone- or glycol-based defoamer. In a further alternative, the defoamer is any known defoamer. In one aspect of the invention, the defoamer removes any air bubbles that are created by any movement of the composition during production.

In accordance with an alternative embodiment, the composition of the present invention can also include a rust inhibitor. The concentration of the rust inhibitor in the composition of the present invention is in an amount ranging from about 0% to about 0.3% by weight. Alternatively, the concentration ranges from about 0.01% to about 0.2% by weight of the composition. In a further alternative, the concentration ranges from about 0.05% to about 0.1% by weight of the composition.

According to one embodiment, the rust inhibitor is sodium nitrite, which can be purchased from Univar Inc. Alternatively, the rust inhibitor can be any known rust inhibitor. In one aspect of the invention, the rust inhibitor inhibits rust in application equipment, such as application “pots,” which are known in the art.

In accordance with an alternative embodiment, the composition of the present invention can also include a preservative. The concentration of the preservative in the composition of the present invention is in an amount ranging from about 0% to about 0.5% by weight. Alternatively, the concentration ranges from about 0.05% to about 0.4% by weight of the composition. In a further alternative, the concentration ranges from about 0.1% to about 0.25% by weight of the composition.

According to one embodiment, the preservative is a bicyclic oxazolidine such as, for example, Nuosept 95, which can be purchased from Creanova Inc., which is located at 220 Davidson Ave., N.J. 08873. Alternatively, the preservative can be, for example, any of the phenolics, halogen organobromides, organometallics, or organosulfur preservatives. Examples of useful preservatives include such as Dowicide® A from Dow Chemical Company (Midland Mich.), Tektamer® from Univar USA Inc. (Los Angeles, Calif.), Troysans® from Chemo Int'l Limited (Miami, Fla.), and Kathon™ from Rohm & Haas Company (Dallas, Tex.). In a further alternative, the preservative can be methyl paraffin or methyl parasept. In a further alternative, the preservative can be any known preservative. In one aspect of the invention, the preservative inhibits biological growth. According to one embodiment, the preservative prevents biological growth for at least 90 days.

In one aspect of the present invention, the composition is made in the following manner. First, a portion of the water to be included in the composition is heated. According to one embodiment, some portion of the surfactant is included in the water prior to or during the heating. Next, the medium or long chain hydrocarbon component is added to the water. Typically, the hydrocarbon component is added while agitation is applied to the mixture, thereby helping to disperse the hydrocarbon component in the water. In one aspect of the invention, the water, surfactant, hydrocarbon component can be added in any order and the heating step can be performed at any point during the addition of the three components.

The base is then added to the mixture. According to one embodiment, a sufficient amount of base is added to bring the pH level of the mixture to from about 8 to about 9. Then the mixture is stirred. The composition is then cooled below the solidification point of the hydrocarbon component. More water is then added, followed by the acidulant. In one aspect of the invention, sufficient acidulant is added to bring the pH level of the mixture to from about 5.5 to about 8.5. Alternatively, sufficient acidulant is added to bring the pH level to from about 6.0 to about 8.0. In a further alternative, sufficient acidulant is added to bring the pH level to from about 6.5 to about 7.5. Finally, water is added to the composition to create a light paste consistency.

Additional components, such as preservative or defoamer, can be added at any point during the preparation of the composition.

Alternatively, the composition can be prepared by any known method.

In use, the composition of the present invention can be applied to a substrate to be bonded with another substrate. That is, the composition can be placed into known application equipment and applied to the substrate. According to one embodiment, the composition can be, for example, extruded or sprayed onto the substrate. For example, the composition can be placed into an extrusion device. For example, appropriate extrusion devices are available from Rocol. The composition is then applied to the substrate using the equipment. Finally, the substrate to which the composition was applied is mated with a second substrate. Alternatively, the composition is applied by any known method.

According to one embodiment, the substrate is lotioned tissue. Alternatively, the substrate is standard, non-lotioned tissue. In a further alternative, the substrate is any known paper product.

After the mating of the two substrates, the composition exhibits adhesion that causes a bond to form between the two substrates. A wet bond (or “wet tack”) forms in a time period ranging from about 0.1 seconds to about 20 seconds after application. Alternatively, the bond forms almost immediately after application.

According to one embodiment, once the bond has formed, the strength of the bond while the adhesive is still wet (also referred to as the “wet bond” or “wet tack”) ranges from about 3 grams to about 5 grams when a standard roll of tissue with a width of 4.5 inches is tested using the Wet Bond Test as described below. Alternatively, the wet bond strength is about 4 grams using the Wet Bond Test. Given that existing adhesives in the prior art exhibit a maximum wet bond strength on lotioned tissue of about 1 gram using the Wet Bond Test, the adhesive composition of the present invention has a wet bond strength that is about 4 times higher than existing adhesives.

Once the adhesive has dried, the strength of the bond (also referred to as the “dry bond”) ranges from about 15 grams to about 200 grams using the Dry Bond Test as described below. Alternatively, the dry bond strength ranges from about 50 grams to about 150 grams. In a further alternative, the dry bond strength ranges from about 60 grams to about 85 grams.

Although the present invention has been described with reference to preferred embodiments, persons skilled in the art will recognize that changes may be made in form and detail without departing from the spirit and scope of the invention. While multiple embodiments are disclosed, still other embodiments of the present invention will become apparent to those skilled in the art from the following detailed description, which shows and describes illustrative embodiments of the invention and is to be regarded as illustrative in nature and not restrictive.

The following example is presented by way of demonstration, and not limitation, of the invention. Unless indicated otherwise, the following testing procedures were employed:

Wet Bond Test—The wet bond test is a test of the adhesive strength of an adhesive composition when the composition is still wet. The test is performed in the following manner. The substrate, which is a standard-sized roll of tissue (4.5 inches wide) is positioned such that the axis of the core of the roll is horizontal. For example, a bar can be inserted through the core of the roll and then the bar can be positioned horizontally. A 3/32-inch-wide line of the adhesive composition to be tested is applied to the tissue from one edge to the other across the width of the tissue about 2 inches from the tail or end of the tissue. The roll is then rotated until the tail is positioned directly beneath the bar, and weights are attached to the tail. Weights are attached until the adhesive fails and the tail pulls away from the roll. The maximum amount of weight that can be successfully attached without adhesive failure is the amount recorded as the adhesive wet tack strength.

Dry Bond Test—The dry bond test is a test of the adhesive strength of an adhesive composition after the composition has dried. The adhesive is applied to the tail of a standard-sized roll of tissue as described above for the Wet Bond Test. After the composition has dried, the roll is placed onto a paint roller frame which is affixed to a heavy weight and is positioned on an electronic balance which has been tared to zero reading. The tail is pulled straight up from the assembly and as the glue line is approached, the pull exerted on the bond line is administered slowly and steady until the entire bond line is ruptured or released. A visual reading of the maximum (negative) value is noted as indicated by the electronic digital balance, the pull being exerted on the tail decreasing the load on the balance pan and indicated as a negative value. An average of all the bond lines is calculated and used for comparative purposes.

### EXAMPLE 1

Methods and Materials

The following experiment involved four different embodiments (“samples”) of the present invention, testing various characteristics of each sample.

Sample 1 was comprised of the following (provided in percentage by weight):

| | |
|---|---|
| MYRJ ™ 45 | 2.56% |
| Emersol 132 NF Lily Stearic Acid | 2.56% |
| Glycerin | 0.56% |
| Kaydol White Mineral Oil | 0.33% |
| KOH (45% solution) | 0.50% |
| Colloid 962 Defoamer | 0.09% |
| Citric acid | 0.10% |
| Sodium nitrite | 0.06% |
| Nuosept 95 | 0.15% |
| Water | 93.09% |

Sample 1 was prepared as follows. The MYRJ™ 45, stearic acid, glycerin, mineral oil, and 15.56% of the water was mixed together and heated to 155° F. Then the KOH was added and mixed for 5 minutes, then the mixture was cooled to 120° F. Subsequently, the defoamer and 33.33% of the water was added and the mixture was mixed for 10 minutes. Then the citric acid and sodium nitrite were added to the mixture and mixed for 45 to 60 minutes. Finally, 44.2 wt. % of water and the Nuosept 95 was added.

Sample 2 was comprised of the following:

| | |
|---|---|
| MYRJ ™ 45 | 2.56% |
| Emersol 132 NF Lily Stearic Acid | 2.56% |
| Glycerin | 2.56% |
| KOH (45% solution) | 0.40% |
| Colloid 962 Defoamer | 0.06% |
| Citric Acid | 0.10% |
| Sodium nitrite | 0.06% |
| Nuosept 95 | 0.15% |
| Water | 91.55% |

Sample 2 was prepared as follows. The MYRJ™ 45, stearic acid, glycerin, and 15.56% of the water was mixed together and heated to 155° F. Then the KOH and 0.40% of the water was added and mixed for 5 minutes, then the mixture was cooled to 120° F. Subsequently, the defoamer and 33.33% of the water was added and the mixture was mixed for 10 minutes. Then the citric acid and sodium nitrite were added to the mixture and mixed for 45 to 60 minutes. Finally, 42.26 wt. % of water and the Nuosept 95 were added.

Sample 3 was comprised of the following:

| | |
|---|---|
| MYRJ ™ 45 | 2.56% |
| Emersol 132 NF Lily Stearic Acid | 2.56% |
| Glycerin | 2.56% |
| Kaydol White Mineral Oil | 0.30% |
| KOH (45% solution) | 0.40% |
| Colloid 962 Defoamer | 0.06% |
| Citric Acid | 0.10% |
| Sodium nitrite | 0.06% |
| Nuosept 95 | 0.15% |
| Water | 91.25% |

Sample 3 was prepared as follows. The MYRJ™ 45, stearic acid, glycerin, mineral oil, and 15.56% of the water was mixed together and heated to 155° F. Then the KOH and 0.40 % of the water was added and mixed for 5 minutes, then the mixture was cooled to 120° F. Subsequently, the defoamer and 33.35% of the water was added and the mixture was mixed for 10 minutes. After the defoamer and water were added, the mixture exhibited a pH level of 8.1. Then the citric acid, sodium nitrite, and Nuosept 95 were added to the mixture and mixed for 45 to 60 minutes. After the nitrite was added, the pH level was 7.8, and after the citric acid was subsequently added (after the nitrite), the pH level was 6.9. Finally, 41.94 wt. % of water was added.

Sample 4 was comprised of the following (provided in percentage by weight):

| | |
|---|---|
| MYRJ ™ 45 | 2.56% |
| Emersol 132 NF Lily Stearic Acid | 2.56% |
| Glycerin | 0.56% |
| Kaydol White Mineral Oil | 0.33% |
| KOH (45% solution) | 0.38% |
| Rhodoline 962 Defoamer | 0.09% |
| Cream of Tartar | 0.23% |
| Sodium nitrite | 0.06% |
| Nuosept 95 | 0.15% |
| Water | 93.08% |

Sample 4 was prepared as follows. The MYRJ™ 45, stearic acid, glycerin, mineral oil, and 15.56% of the water was mixed together and heated to 155° F. Then the KOH was added and mixed for 5 minutes, then the mixture was cooled to 120° F. Subsequently, the defoamer and 33.33% of the water was added and the mixture was mixed for 10 minutes. Then the cream of tartar and sodium nitrite were added to the mixture and mixed for 45 to 60 minutes. Finally, 44.19 wt. % of water and the Nuosept 95 was added.

Results

The results are as follows. Sample 1 exhibited a viscosity of 2400 cps at 85° F. The sample had a pH of about 6.8 to about 7.2 and exhibited 5.5 to 6.5% solids. When the composition was tested using Wet Bond Test as set forth above, the composition exhibited a wet tack strength of 1.9 gms. When the composition was tested using the Dry Bond Test as set forth above, the composition exhibited a dry bond strength of 45 gms.

Sample 2 exhibited a viscosity of 2400 cps at 85° F. The sample had a pH of about 6.8 to about 7.2 and exhibited 5.5 to 6.5% solids. When the composition was tested using Wet Bond Test, the composition exhibited a wet tack strength of 1.9 gms. When the composition was tested using the Dry Bond Test as set forth above, the composition exhibited a dry bond strength of 106 gms.

Sample 3 exhibited a viscosity of 2750 cps at 85° F. The sample had a pH of about 6.8 to about 7.2 and exhibited 5.5 to 6.5% solids. When the composition was tested using Wet Bond Test, the composition exhibited a wet tack strength of 5.1 gms. When the composition was tested using the Dry Bond Test as set forth above, the composition exhibited a dry bond strength of 79 gms.

Sample 4 exhibited a viscosity of 2700 cps at 85° F. The sample had a pH of about 6.8 to about 7.2 and exhibited 5.5 to 6.5% solids. When the composition was tested using Wet Bond Test, the composition exhibited a wet tack strength of 5.1 gms. When the composition was tested using the Dry Bond Test as set forth above, the composition exhibited a dry bond strength of 45 gms.

What is claimed is:

1. An adhesive composition comprising:
(a) from about 1% by weight to about 4% by weight of a hydrocarbon component;
(b) from about 0.5% by weight to about 5% by weight of a surfactant;
(c) from about 0.1% by weight to about 0.8% by weight of a base; and
(d) from about 0.1% by weight to about 0.4% by weight of an acidulant; and
(e) water in an amount such that the composition totals 100% in weight.

2. The composition of claim 1 further comprising from about 0.05% by weight to about 3% by weight of a light hydrocarbon oil.

3. The composition of claim 2 wherein the light hydrocarbon oil comprises a mineral oil.

4. The composition of claim 1 further comprising a coupling agent.

5. The composition of claim 4 wherein the coupling agent comprises glycerin.

6. The composition of claim 1 further comprising a defoamer.

7. The composition of claim 1 further comprising a rust inhibitor.

8. The composition of claim 1 further comprising a preservative.

9. The composition of claim 1, wherein the preservative comprises bicyclic oxazolidine, phenolics, halogen organobromides, organometallics, organosulfurs, methyl paraffin, methyl parasept, or combinations thereof.

10. The composition of claim 1 wherein the hydrocarbon component comprises an aliphatic carboxylic acid.

11. The composition of claim 9 wherein the aliphatic carboxylic acid comprises stearic acid.

12. The composition of claim 1 wherein the surfactant comprises a surfactant having an HLB value of from about 10.0 to about 12.0.

13. The composition of claim 1 wherein the base comprises potassium hydroxide.

14. The composition of claim 1 wherein the acidulant comprises citric acid.

15. The composition of claim 1 wherein the composition has a pH level of from about 5.5 to about 8.5.

16. A method of making an adhesive composition comprising:
combining water, a surfactant, and a hydrocarbon component to create a mixture;
adding a base to the mixture in an amount sufficient to cause the pH level to move toward a range of from about 8 to about 9; and
adding an acidulant to the mixture to adjust the pH level to a range of from about 6 to about 8.

17. A method of using an adhesive composition comprising:
providing an adhesive composition comprising:
(a) a hydrocarbon component comprising stearic acid; and
(b) a surfactant; and
applying the adhesive composition to a paper product.

18. The method of claim 16 wherein the paper product is a lotioned paper product.

19. The method of claim 16 wherein the composition further comprises:
(a) a base; and
(b) an acidulant.

20. A method of using an adhesive composition comprising:
providing an adhesive composition comprising:
(a) from about 1% by weight to about 4% by weight of a hydrocarbon component comprising stearic acid;
(b) from about 0.5% by weight to about 5% by weight of a surfactant;
(c) from about 0.1% by weight to about 0.8% by weight of a base;
(d) from about 0.1% by weight to about 0.4% by weight of an acidulant;
(e) a light hydrocarbon oil comprising a mineral oil; and
(f) a coupling agent comprising glycerin; and applying the adhesive composition to a lotioned paper product.
